(19) United States
(12) Patent Application Publication
(10) Pub. No.: US 2015/0294652 A1
(43) Pub. Date: Oct. 15, 2015

(54) FASTENING DEVICE FOR AN ELECTRIC GUITAR

(71) Applicant: TRUETREMOLO SCANDINAVIA AB, Stockholm (SE)

(72) Inventor: Anders Thidell, Sodertalje (SE)

(73) Assignee: TRUETREMOLO SCANDINAVIA AB, Stockholm (SE)

(21) Appl. No.: 14/437,653

(22) PCT Filed: Sep. 17, 2013
(86) PCT No.: PCT/SE2013/051081

§ 371 Date: Apr. 22, 2015

(30) Foreign Application Priority Data
Oct. 24, 2012 (SE) 1251200-0

(51) Int. Cl. G10D 3/14; G10D 3/12; G10D 1/08

(52) U.S. Cl. CPC G10D 3/146; G10D 3/14; G10D 1/085; G10D 3/12

(57) ABSTRACT

String fastener in the guitar body of an electric guitar, includes a bridge, carrying one saddle per string located at the upper side of the bridge, across which a string is arranged to run, one saddle per string fastened to the upper side, a downwards directed, pivoted lever arranged at each saddle, at which lever one string end is fastened, a tuning spring fastened with one of its ends to the lever and with its other end to the guitar body, which tuning spring strives to maintain a constant pulling force in a string, and which string fastener is provided with a vibrato arm, which when activated results in the bridge angling towards the guitar body, the vibrato arm being pivotally fastened to and running through the bridge. A fastening element maintains each lever in position, and a release device cooperates with the fastening element to release the levers.

The present invention relates to a device for string instruments, more particularly to a string fastener in the guitar body of an electric guitar.

All strings on an electric guitar have, at a desired tuning of the guitar, different coefficients of elasticity as a result of the loading of the strings using the tuning screws. The coefficients of elasticity of the strings correspond to a pulling force in the strings with a certain number of kilos.

For example, a set of electric guitar strings 10-46 has, at normal tuning, the following pull force for the different strings: E 7.35 kg; B 6.98 kg; G 7.53 kg; D 8.34 kg; A 8.84 kg and E 7.94 kg.

A known device is arranged so that each string is fastened to a tuning screw, and in the opposite end is fastened to a lever in a string fastener. A tuning spring is fastened between the lever and the guitar body. The tuning spring is adjustably fastened along the lever.

If a string is affected by some circumstance, such as a temperature modification or a physical impact, the tuning spring compensates, via the lever, the original pull force in the string without the tuning screw having to be adjusted.

Certain guitars are made with so called tremolo designs, designed to perform a vibrato, in other words a pitch alteration via either a slacking of the strings or an increased string tension via a vibrato device. A vibrato device is usually designed so that the string fastener is folded upwards or downwards in relation to the guitar body using a vibrato arm. This results in that the strings are slackened or stretched. A guitar with a vibrato feature does not have any tuning springs; instead the strings are fastened to the string fastener with no resiliency. This results in the disadvantage that the guitar does not keep its tuning after one or several strings have been subjected to some circumstance, such as a temperature shift or physical influences.

Should a vibrato-capable guitar be equipped with tuning springs, the tuning springs would compensate for the altered tension as the tension in the springs are modified as a result of application of vibrato, whereby vibrato effect would completely or partly fail to occur.

The present invention solves this problem, and combines the principle of using tuning springs with a vibrato device.

Hence, the present invention relates to a string fastener in the guitar body of an electric guitar, comprising a bridge, carrying one saddle per string located at the upper side of the bridge, across which a string is arranged to run, wherein one saddle per string is fastened to the upper side of the bridge, wherein a downwards directed, pivoted lever is arranged at each saddle, at which lever one end of a string is arranged to be fastened, wherein a tuning spring, which is a tension spring, is fastened with one of its ends to the lever and with its other end directly or indirectly to the guitar body, which tuning spring strives to maintain a constant pulling force in a string, and which string fastener is provided with a so-called vibrato arm, which when activated results in that the said bridge is angled towards the guitar body, which vibrato arm is pivotally fastened to the bridge and runs through the bridge, and is characterised in that a fastening means is arranged to maintain each of said levers in its respective position relative to the bridge in a normal play state and during vibrato, and in that a release device is arranged to affect the fastening means to release the said levers.

Below, the invention is described in closer detail, partly in connection to an embodiment of the invention shown in the enclosed drawings, wherein

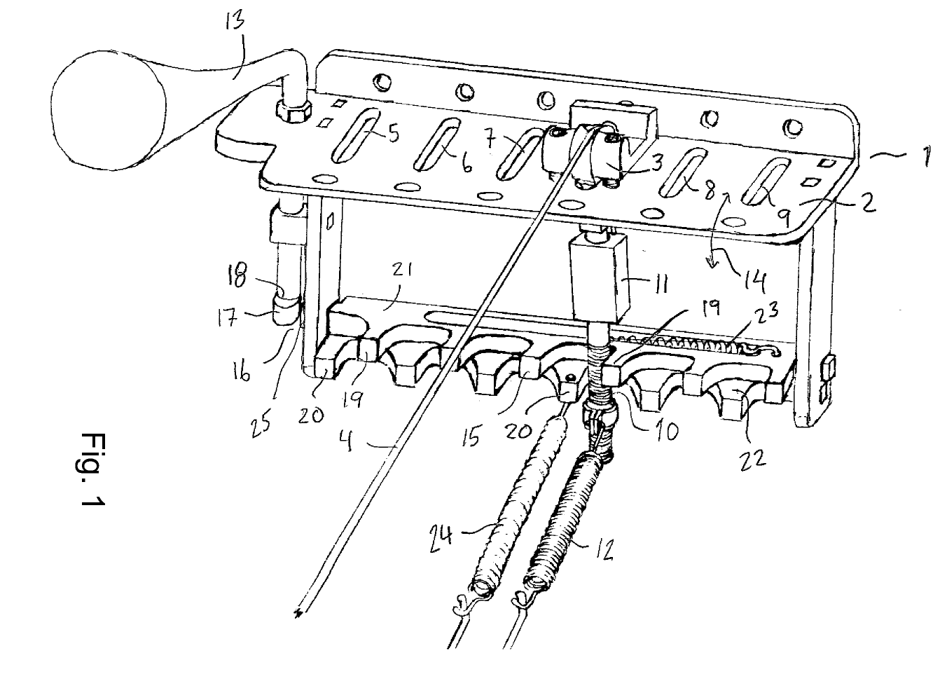

FIG. 1 shows a string fastener and only a fastening means according to a first embodiment according to the invention, in a perspective view

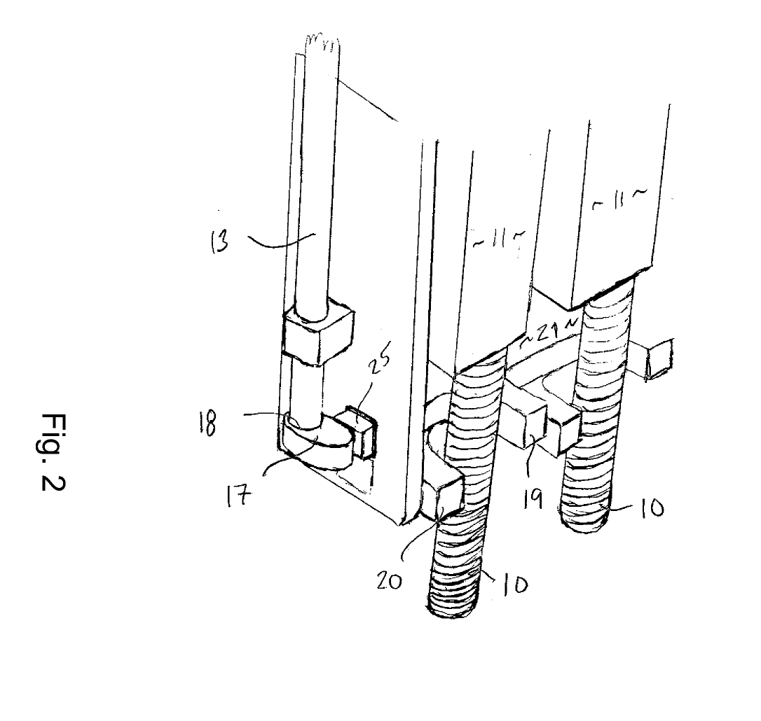

FIG. 2 shows, to a larger scale, the lower left part of the device shown in FIG. 1

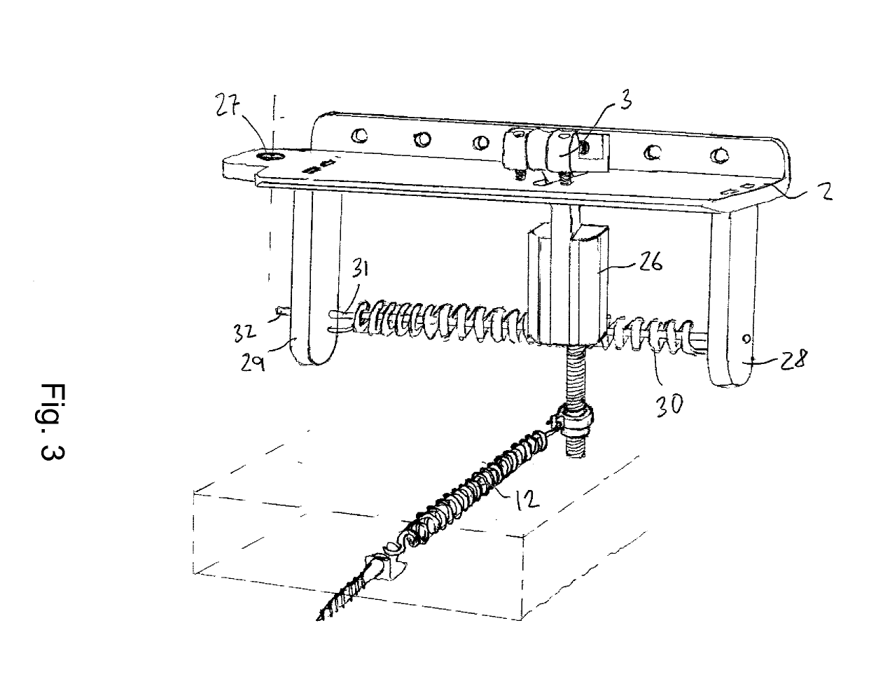

FIG. 3 shows a string fastener and only a body belonging to a fastening means according to a second embodiment according to the invention, in a perspective view

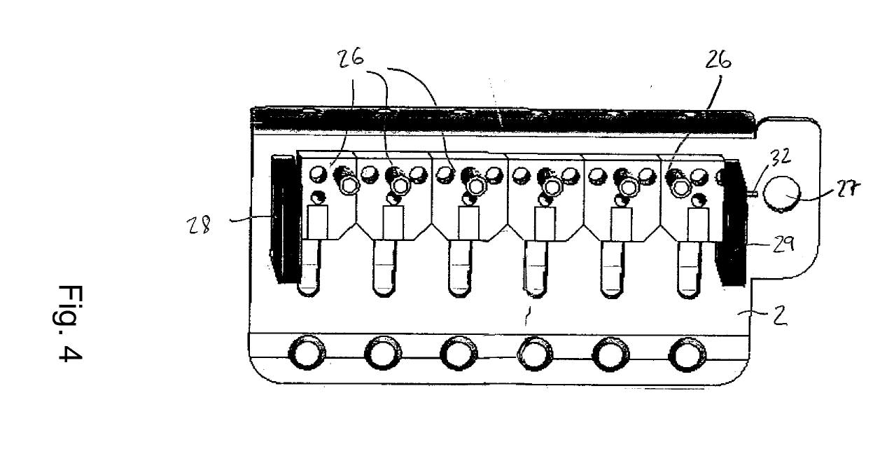

FIG. 4 shows a string fastener as seen from below, with six bodies.

In FIG. 1 is schematically shown a string fastener 1, arranged to be fastened to the guitar body of an electric guitar, not shown. The string fastener comprises a bridge 2 carrying one saddle 3 per string 4, located at the upper side of the bridge, across which a string is arranged to run. In FIG. 1, only one saddle and one string is shown. A respective saddle 3 is to be arranged at each opening 5-9, so that one saddle per string is fastened to the upper side of the bridge 2.

According to a preferred embodiment, each lever 10 is pivotally fastened to a fastener for said saddle 3 about an axis, at which axis the saddle is also fastened, wherein said saddle is semicircle-shaped, where the center of the semicircle coincides with the said axis. This results in that the length of a string between the saddle and the opposite fastening point of the string is constant as the pull force in the string is adjusted using the tuning spring, which strives to maintain the pull force in a string.

A pivoted and downwards directed lever 10 is arranged at each saddle 3, at which lever one end of a string 4 is arranged to be fastened to a fastener 11 which is translatable along the lever.

A tuning spring 12, which is a tension spring, is fastened with one of its ends to each lever 10, and with its other end directly or indirectly to the guitar body. The tuning spring 12 strives to maintain a constant pulling force in a string 4.

The string fastener is provided with a conventional so-called vibrato arm 13, which when activated results in that the said bridge 2 is angled towards the guitar body in the direction of the arrow 14. The vibrato arm 13 is pivotally fastened to the bridge 2, and runs through the bridge through a hole 27 in the same.

According to the invention, there is a fastening means 15, arranged to maintain each of said levers 10 in its respective position relative to the bridge 2 in a normal play state and during vibrato. Moreover, there is a release device 16, which is arranged to affect the fastening means 15 so as to release said levers 10.

When the guitar is tuned and in a normal play state and during vibrato, the fastening means 15 holds the levers 10 fixed in their respective position. This results in that the tensile stress in the strings is not altered by the tuning springs 12, which otherwise would have been the case had the levers not been held fixed. When the vibrato arm is to be maneuvered in the conventional way, so that the bridge 2 is folded, a pitch alteration takes place because of the strings being extended and shortened.

The tensile stress in the strings can be altered during play. By activating the release device 16 to affect the fastening means 15 so as to release the said levers 10, the tuning springs 12 will cause the original tensile stress in the respective strings 4 to be restored, in other words the guitar is tuned to its original tuning state.

Hence, this way a guitar with tuning springs is combined with a vibrato-featured guitar.

According to a preferred embodiment, the release device 16 comprises the vibrato arm 13 and a means 17 which is fastened to the vibrato arm on its free end 18 located on the opposite side of the bridge 2, which means 17 is arranged to, during turning of the vibrato arm in relation to the guitar body to a predetermined position, affect the fastening means 15 to release said levers 10.

According to a first preferred embodiment, the said fastening means 15 comprises, for each lever, two parallel locking arms 19, 20, arranged to abut against each side of the lever 10 when holding the levers fixed.

According to a preferred embodiment, one locking arm out of each pair of locking arms protrudes from a first planar part 21. The second of the locking arms in said pair protrudes from a second planar part 22. The first 21 and the second 22 planar parts are arranged in parallel, and arranged adjacent to each other, so that pairs of locking arms 19, 20 are formed. A tension spring 23 is arranged with a first end fastened to the first planar part 21 and with its other end to the second planar part 22, so that the planar parts 21, 22, when subjected to the spring load, are translated in relation to each other so that each pair of the locking arms 19, 20 is translated into a position in which the levers 10 held fixed.

The said means 17 at the free end 18 of the vibrato arm 13 is arranged to, in a first angular position, the predetermined position, translate the first planar part 21 in relation to the bridge 2, against the spring force of the said spring 23 and also in relation to the second planar part 22, so that the levers 10 are released from the locking arms 19, 20, by the locking arms in each pair of locking arms being distanced from each other. In a second angular position, the said means does not affect the first planar part 21.

It is preferred that the said means 17 is an asymmetric body arranged to act directly onto the first planar part 22, when the vibrato arm 13 is turned to the predetermined position. Suitably, the body is an eccentric body. In FIGS. 1 and 2, a protruding part 25 of the first planar part 21 is shown, against which the said means 17 acts, so that the first planar part 21 is translated.

Hence, a guitarist can turn the vibrato arm to the predetermined position, whereby the levers are released and therefore the tuning springs can, very quickly, result in restored tensile stress in the strings 4.

In FIG. 1, there is also shown a spring 24. The spring 24 is fastened to the second planar part 22 and to the guitar body. The purpose of this spring is to adjust the angle of the bridge 2 in relation to the guitar body in a resting position of the bridge.

According to a second embodiment of the fastening means, each lever 10 is threaded into a body 26, see FIG. 3. In FIG. 4, a string fastener is shown from below, with six bodies 26, in other words one body per string 4. The hole 27 is that through which the vibrato arm is arranged to run. The bodies 26 are positioned along a line next to each other, with a certain play between adjacent bodies, so that the bodies can move without being affected by neighboring bodies. At the respective ends of the line of bodies 26, there is a respective gable 28, 29 arranged, fastened to the bridge 2. The gables are positioned with a certain play between the respective gable and the side surface of the neighboring body 26. A tension spring 30 is arranged, which is fastened to the respective gables 28, 29 so that the gables strive towards each other, whereby the side surfaces of the bodies 26 are pressed towards each other and towards the respective gable 28, 29 to a position in which the levers 10 are held fixed.

One 28 of the gables is somewhat translatably arranged towards and away from the other gable 29, so that a play between the respective bodies 26 can arise.

The said means 17 at the free end of the vibrato arm 13 is arranged to, in a first predetermined angular position in relation to the bridge 2, translate the said first gable 28, against the spring force of said spring 30, in a direction away from the second gable 29, so that the bodies 26 are released from each other, and in a second angular position not to translate the said gable 28 so that a state is assumed in which the levers 10 are held fixed, by the bodies 26 abutting against each other under the influence of the spring force.

The said means 17 is an asymmetrical body, arranged to act against the free end 31 of a rod 32, which rod 31 is fastened to the first gable 28 and runs to the second gable 29 and out through the same with its free end 32.

In FIG. 3, the vibrato arm is not shown, but it is arranged to run through the hole 27. The lower part of the vibrato arm is therefore designed as shown in FIGS. 1 and 2.

By this second embodiment is achieved the same function as according to the first embodiment, namely that the levers are kept fixed during play and when activating vibrato, and that the levers can be released using a turning of the vibrato arm so that the strings are tuned using the tuning springs.

Above, a number of embodiments have been described. However, it is apparent that the mechanical design of the fastening means can be varied without departing from the function of retaining the levers and releasing the levers, respectively, using turning of the vibrato arm.

Therefore, the invention is not to be regarded as limited to the above described embodiments, but can be varied within the scope of the enclosed claims.

1. String fastener (1) in the guitar body of an electric guitar, comprising a bridge (2), carrying one saddle (3) per string located at the upper side of the bridge, across which a string (4) is arranged to run, wherein one saddle (3) per string is fastened to the upper side of the bridge, wherein a downwards directed, pivoted lever (10) is arranged at each saddle, at which lever one end of a string (4) is arranged to be fastened, wherein a tuning spring (12), which is a tension spring, is fastened with one of its ends to the lever (10) and with its other end directly or indirectly to the guitar body, which tuning spring (12) strives to maintain a constant pulling force in a string (4), and which string fastener is provided with a so-called vibrato arm (13), which when activated results in that the said bridge (2) is angled towards the guitar body, which vibrato arm (13) is pivotally fastened to the bridge and runs through the bridge, characterized in that a fastening means (15) is arranged to maintain each of said levers (10) in its respective position relative to the bridge in a normal play state and during vibrato, and in that a release device (16) is arranged to affect the fastening means (15) to release the said levers (10).

2. String fastener according to claim 1, characterized in that the release device (16) comprises the vibrato arm (13) and a means (17) which is fastened to the vibrato arm on its free end located on the opposite side of the bridge (2), which means (17) is arranged to, during turning of the vibrato arm (13) in relation to the guitar body to a predetermined position, affect the fastening means (15) to release said levers (10).

3. String fastener according to claim 1, characterized in that the said fastening means (15) comprises, for each lever (10), two parallel locking arms (19,20), arranged to abut against each side of the lever (10) when holding the levers fixed.

4. String fastener according to claim 1, characterized in that one (19) out of each pair of locking arms protrudes from a first planar part (21), in that the second (20) of the locking arms in said pair protrudes from a second planar part (22), in that the first (21) and the second (22) planar part are arranged in parallel, and arranged adjacent to each other and translatable in relation to each other, so that pairs of locking arms (19,20) are formed, and in that a spring (23) is arranged with a first end fastened to the first planar part (21) and with its other end to the second planar part (22), so that the planar parts, when spring loaded, are translated in relation to each other so that each pair of the locking arms is translated to a position in which the levers (10) are held fixed.

5. String fastener according to claim 4, characterized in that the said means (17) at the free end (18) of the vibrato arm (13) is arranged to, in a first angular position in relation to the bridge (2), translate the first planar part (21) against the spring force of the said spring in relation to the second planar part (22), so that the levers (10) are released from the locking arms, and in that, in a second angular position, it does not affect the first planar part (21).

6. String fastener according to claim 4, characterized in that the said means (17) is an asymmetric body arranged to act directly onto the first planar part (21).

7. String fastener according to claim 1, characterized in that each lever (10) is threaded into a body (26), which bodies are positioned in a line next to each other with a certain play between adjacent bodies (26), so that the bodies can move without being affected by neighboring bodies, in that, at the respective ends of the line of bodies (26), there is arranged a respective gable (28,29), fastened to the bridge (2) and positioned with a certain play between the respective gable (28,29) and the side surface of the neighboring body (26), in that one of the gables (28) is translatable towards and away from the other gable (29), in that there is a tension spring (30) arranged, which is fastened to the respective gables (28,29) so that the gables strive towards each other, whereby the side surfaces of the bodies (26) are pressed towards each other and towards the respective gable (29,28) to a position in which the levers (10) are held fixed, and in that the gables (28,29) are translatable away from each other to a position in which the levers (10) are released.

8. String fastener according to claim 7, characterized in that the said means (17) at the free end (18) of the vibrato arm (13) is arranged to, in a first predetermined angular position in relation to the bridge (2), translate the said one, first, gable (28), against the spring force of said spring (30), in a direction away from the second gable (29), so that the bodies (26) are released from each other, and in that, in a second angular position, not to translate the said gable (28), so that a location is assumed in which the levers (10) are held fixed, by the bodies (26) abutting against each other.

9. String fastener according to claim 7, characterized in that the said means (17) is an asymmetrical body, arranged to act against the free end (32) of a rod (31), which rod (31) is fastened to the first gable (28) and runs to the second gable (29) and out through the same with its free end (32).

10. String fastener according to claim 1, characterized in that each lever (10) is pivotally fastened to a fastener for the said saddle (3) about an axis, at which axis also the saddle (3) is fastened, and in that the said saddle is semicircle-shaped, where the center of the semicircle coincides with the said axis.

11. String fastener according to claim 2, characterized in that the said fastening means (15) comprises, for each lever (10), two parallel locking arms (19,20), arranged to abut against each side of the lever (10) when holding the levers fixed.

12. String fastener according to claim 2, characterized in that one (19) out of each pair of locking arms protrudes from a first planar part (21), in that the second (20) of the locking arms in said pair protrudes from a second planar part (22), in that the first (21) and the second (22) planar part are arranged in parallel, and arranged adjacent to each other and translatable in relation to each other, so that pairs of locking arms (19,20) are formed, and in that a spring (23) is arranged with a first end fastened to the first planar part (21) and with its other end to the second planar part (22), so that the planar parts, when spring loaded, are translated in relation to each other so that each pair of the locking arms is translated to a position in which the levers (10) are held fixed.

13. String fastener according to claim 2, characterized in that each lever (10) is threaded into a body (26), which bodies are positioned in a line next to each other with a certain play between adjacent bodies (26), so that the bodies can move without being affected by neighboring bodies, in that, at the respective ends of the line of bodies (26), there is arranged a respective gable (28,29), fastened to the bridge (2) and positioned with a certain play between the respective gable (28,29) and the side surface of the neighboring body (26), in that one of the gables (28) is translatable towards and away from the other gable (29), in that there is a tension spring (30) arranged, which is fastened to the respective gables (28,29) so that the gables strive towards each other, whereby the side surfaces of the bodies (26) are pressed towards each other and towards the respective gable (29,28) to a position in which the levers (10) are held fixed, and in that the gables (28,29) are translatable away from each other to a position in which the levers (10) are released.

14. String fastener according to claim 3, characterized in that one (19) out of each pair of locking arms protrudes from a first planar part (21), in that the second (20) of the locking arms in said pair protrudes from a second planar part (22), in that the first (21) and the second (22) planar part are arranged in parallel, and arranged adjacent to each other and translatable in relation to each other, so that pairs of locking arms (19,20) are formed, and in that a spring (23) is arranged with a first end fastened to the first planar part (21) and with its other end to the second planar part (22), so that the planar parts, when spring loaded, are translated in relation to each other so that each pair of the locking arms is translated to a position in which the levers (10) are held fixed.

15. String fastener according to claim 5, characterized in that the said means (17) is an asymmetric body arranged to act directly onto the first planar part (21).

16. String fastener according to claim 8, characterized in that the said means (17) is an asymmetrical body, arranged to act against the free end (32) of a rod (31), which rod (31) is fastened to the first gable (28) and runs to the second gable (29) and out through the same with its free end (32).

17. String fastener according to claim 12, characterized in that the said means (17) at the free end (18) of the vibrato arm (13) is arranged to, in a first angular position in relation to the bridge (2), translate the first planar part (21) against the spring force of the said spring in relation to the second planar part (22), so that the levers (10) are released from the locking arms, and in that, in a second angular position, it does not affect the first planar part (21).

18. String fastener according to claim 14, characterized in that the said means (17) at the free end (18) of the vibrato arm (13) is arranged to, in a first angular position in relation to the bridge (2), translate the first planar part (21) against the spring force of the said spring in relation to the second planar part (22), so that the levers (10) are released from the locking arms, and in that, in a second angular position, it does not affect the first planar part (21).

19. String fastener according to claim 13, characterized in that the said means (17) at the free end (18) of the vibrato arm (13) is arranged to, in a first predetermined angular position in relation to the bridge (2), translate the said one, first, gable (28), against the spring force of said spring (30), in a direction away from the second gable (29), so that the bodies (26) are released from each other, and in that, in a second angular position, not to translate the said gable (28), so that a location is assumed in which the levers (10) are held fixed, by the bodies (26) abutting against each other.
